(19) United States
(12) Patent Application Publication
(10) Pub. No.: US 2023/0076222 A1
(43) Pub. Date: Mar. 9, 2023

(54) Ankle Exoskeleton

(71) Applicant: Photomics, Inc., Berkeley, CA (US)

(72) Inventor: Henry PINKARD, Berkeley, CA (US)

(21) Appl. No.: 17/939,590

(22) Filed: Sep. 7, 2022

Related U.S. Application Data
(60) Provisional application No. 63/241,736, filed on Sep. 8, 2021.

(51) Int. Cl. B25J 9/00; A61H 1/02

(52) U.S. Cl. CPC B25J 9/0006; A61H 1/0262; A61H 2003/007

(57) ABSTRACT

An ankle exoskeleton device is provided having a lower leg anchor, a foot/ankle anchor, a first actuator and a second actuator. The first actuator includes an upper end disposed at a first anchor point on the right side of the foot/ankle anchor and a lower end disposed at a second anchor point on the right side of the lower leg anchor. The first actuator includes a first biasing mean having a neutral position when the ankle is in a neutral position. The first biasing means provides for compression loading due to ground reaction forces on the foot/ankle anchor to provide a cushioning effect on the ankle as the being takes a step. The second actuator provides for substantially the same elements on the left side of the foot/ankle anchor and the lower leg anchor.

### CROSS REFERENCE TO RELATED APPLICATION

This application claims priority to U.S. Provisional Application No. 63/241,736, filed Sep. 8, 2021, entitled Ankle Exoskeleton and Method of Fabrication, the complete specification of which is fully incorporated by reference, pending.

### BACKGROUND OF THE INVENTION

Osteoarthritis of the ankle is a painful and debilitating condition that affects an estimated 1% of the population. It most commonly occurs after a traumatic injury to the ankle, such as a tear of the anterior talofibular ligament. This can lead to chronic ankle instability, which typically feels to patients like the ankle is “giving way,” and may lead to multiple subsequent sprains or other injuries. This condition is thought to cause and accelerate the progression of ankle osteoarthritis.

The mechanical mechanisms by which this occurs are starting to become better understood. Instability has been shown to increase peak strain, and cause a shifting of peak strain location within the ankle joint compared to uninjured controls. That such a mechanical shift would cause and worsen the progression of ankle osteoarthritis is consistent with observational data indicating that being overweight, which is also thought to increase mechanical stresses on joints, worsens osteoarthritis.

Severe ankle arthritis can be treated surgically, but with limited success. The most common surgical treatments are ankle fusion or total ankle replacement. However, the former disrupts normal biomechanics and can lead to issues in other joints, and the latter often fails and requires additional treatment within 10 years. A less common surgical treatment is joint distraction, in which a metal cage is place around the lower leg with pins sticking through the skin into the ankle. This is held in place for 6 weeks with the foot pulled away from the rest lower leg. It is not totally understood why this procedure often leads to success, though it may be that the force reduction/mechanical change enables productive healing of the joint.

A way to realize beneficial mechanical changes without the need for extreme and/or risky surgical approaches would be a welcome advance in the state of the art.

Numerous designs in the prior art have been described for ankle exoskeletons. However, their typical aim is to assist the musculature of the ankle, through either a battery-powered mechanism, or a passive energy storage mechanism that absorbs energy in one part of the gait cycle and uses it to actuate the joint in another part of the gate cycle.

Additionally, there are also numerous existing “ankle braces.” These typically aim to stabilize the joint in some way rather than assist in the actuation of muscles. Almost all provide some degree of protection against lateral inversion (i.e., “rolling your ankle”). Many also provide some degree of medial-lateral stabilization. Some allow for movement of the ankle, while others keep in rigidly fixed.

### SUMMARY OF THE INVENTION

The present invention is directed to an ankle exoskeleton device for an ankle of a being where the being has a lower leg and an ankle. The ankle exoskeleton device includes a lower leg anchor having a left side and a right side, a foot/ankle anchor having a left side and a right side, a first anchor and a second actuator. The first actuator includes an upper end disposed at a first anchor point on the right side of the foot/ankle anchor and a lower end disposed at a second anchor point on the right side of the lower leg anchor. The first actuator also includes a first biasing means having a neutral position when the ankle is in a neutral position. The first biasing means provides for compression loading due to ground reaction forces on the foot/ankle anchor to provide a cushioning effect on the ankle as the being takes a step. The second actuator includes an upper end disposed at a third anchor point on the left side of the foot/ankle anchor and a lower end disposed at a fourth anchor point on the left side of the lower leg anchor. The second actuator also includes a second biasing means having a neutral position when the ankle is in a neutral position. The first second means providing for compression loading due to ground reaction forces on the foot/ankle anchor to provide a cushioning effect on the ankle as the being takes a step. That is, the device mechanically cushions and stabilizes the ankle along anterior-posterior and medial-lateral directions of the ankle.

For purposes of the present invention, the term “tension loading” is intended to include release or relaxation of compression loading, not requiring necessarily actual tension on the biasing means.

The first actuator may include a first rod having a first end extending from one of the first anchor point and the second anchor point wherein the first biasing means extends from a second end of the first rod to the other of the first anchor point and the second anchor point. The second actuator may also have a second rod including a first end extending from one of the third anchor point and the fourth anchor point wherein the second biasing means extends from a second end of the second rod to the other of the third anchor point and the fourth anchor point.

The biasing means may be a coil spring. The coil springs comprise replaceable springs of varying spring rates to provide for tuning. The neutral positions of the first and second actuators may include biasing means that are pre-loaded to achieve forces that are most consistent with the mechanical properties of uninjured joints. The first actuator may have an upper end that includes a first swivel joint attachment for attachment to the first anchor point, and the first actuator may have a lower end that includes a second swivel joint attachment for attachment of the lower end to the second anchor point. The second actuator may have an upper end that includes a third swivel joint attachment for attachment of the upper end to the third anchor point, and may have a lower end that includes a fourth swivel joint attachment for attachment of the lower end to the fourth anchor point. The first rod and the second rod may be threaded to provide for length adjustment. The biasing means may be tunable to provide for a desired spring rate. The foot/ankle anchor and the lower leg anchor may be manufactured from, for example, a composite material or a moldable thermoplastic material. The foot/ankle anchor and the lower leg anchor may have adjustable straps adapted for securement.

In a second, more detailed exemplary embodiment of the present invention, an ankle exoskeleton device for use on an ankle of a being is provided, the being having a lower leg and an ankle. The ankle exoskeleton device includes a lower leg anchor having a left side and a right side, a foot/ankle anchor having a left side and a right side, a first actuator and a second actuator. The first actuator includes an upper end disposed at a first anchor point on the right side of the foot/ankle anchor and a lower end disposed at a second anchor point on the right side of the lower leg anchor. The first actuator includes a first coil spring, the first coil spring having a neutral position when the ankle is in a neutral position. The first biasing means provides for compression loading due to ground reaction forces on the foot/ankle anchor to provide a cushioning effect on the ankle as the being takes a step. The first actuator further includes a first rod having a first end extending from one of the first anchor point and the second anchor point, and wherein the first coil spring extends from a second end of the first rod to the other of the first anchor point and the second anchor point.

The second actuator includes an upper end disposed at a third anchor point on the left side of the foot/ankle anchor and a lower end disposed at a fourth anchor point on the left side of the lower leg anchor. The second actuator further includes a second coil spring, where the second coil spring has a neutral position when the ankle is in a neutral position. The second biasing means provides for compression loading due to ground reaction forces on the foot/ankle anchor to provide a cushioning effect on the ankle as the being takes a step. The second actuator includes a second rod having a first end extending from one of the third anchor point and the fourth anchor point, and a second coil spring extending from a second end of the second rod to the other of the third anchor point and the fourth anchor point. The device mechanically cushions and stabilizes the ankle along anterior-posterior and medial-lateral directions of the ankle.

The neutral positions of the first and second actuators may include the coil springs that are pre-loaded to achieve forces that are most consistent with the mechanical properties of uninjured joints. The first actuator may have an upper end that includes a first swivel joint attachment for attachment to the first anchor point, and the first actuator may have a lower end that includes a second swivel joint attachment for attachment of the lower end to the second anchor point. The second actuator may have an upper end that includes a first swivel joint attachment for attachment of the upper end to the third anchor point, and the second actuator may have a lower end that includes a second swivel joint attachment for attachment of the lower end to the fourth anchor point. The first rod and the second rod may be threaded to provide for length adjustment. The coil springs may include replaceable springs of varying spring rates to provide for tuning. The foot/ankle anchor and the lower leg anchor may be manufactured from a composite material or a moldable thermoplastic material. The foot/ankle anchor and the lower leg anchor may have adjustable straps.

### BRIEF DESCRIPTION OF THE DRAWINGS

FIG. 1A is a simplified side elevation view of an ankle exoskeleton device in accordance with an exemplary embodiment of the present invention.

FIG. 1B is a simplified front elevation view of the ankle exoskeleton device of FIG. 1A.

FIG. 2A is a simplified top plan view of a foot/ankle anchor of the ankle exoskeleton device of FIGS. 1A and 1B.

FIG. 2B is a simplified top plan view of a lower leg anchor of the ankle exoskeleton device of FIGS. 1A and 1B.

FIG. 3A is a simplified front elevation view of a lower leg anchor of FIGS. 2A and 2B and first and second actuators of the ankle exoskeleton device of FIGS. 1A and 2A, with the foot/ankle anchor removed for clarity.

FIG. 3B is a simplified rear elevation view of a lower leg anchor of FIGS. 2A and 2B and first and second actuators of the ankle exoskeleton device of FIGS. 1A and 2A, with the foot/ankle anchor removed for clarity.

FIG. 3C is a simplified side elevation view of a lower leg anchor of FIGS. 2A and 2B and first and second actuators of the ankle exoskeleton device of FIGS. 1A and 2A, with the foot/ankle anchor removed for clarity.

FIG. 4A is a simplified side elevation view of a foot/ankle anchor and a portion of an actuator of the ankle exoskeleton device of FIGS. 1A and 2A, with the lower leg anchor removed for clarity.

FIG. 4B is a simplified front elevation view of a foot/ankle anchor and a portion of an actuator of the ankle exoskeleton device of FIGS. 1A and 2A, with the lower leg anchor removed for clarity.

### DETAILED DESCRIPTION

The present invention is directed to an ankle exoskeleton device which mechanically unloads and cushions the ankle, stabilizes it along anterior-posterior and medial-lateral directions, while allowing for relatively normal biomechanics.

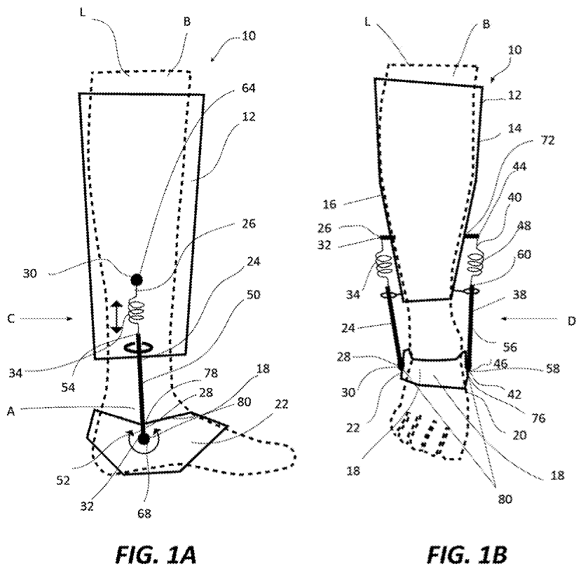

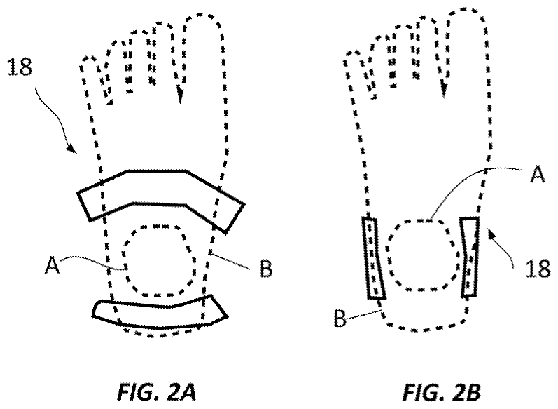

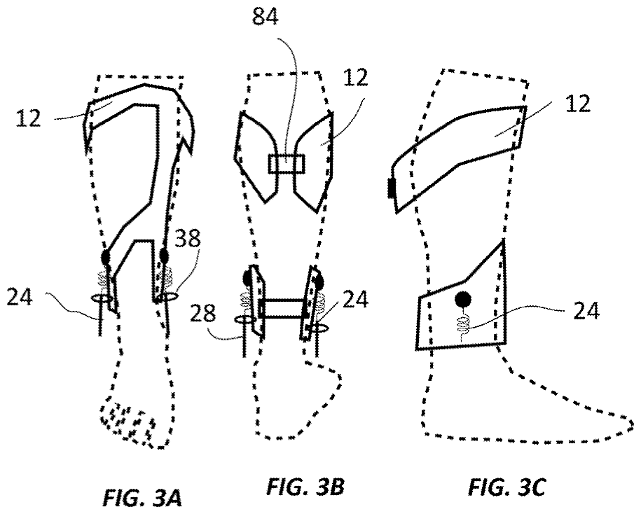

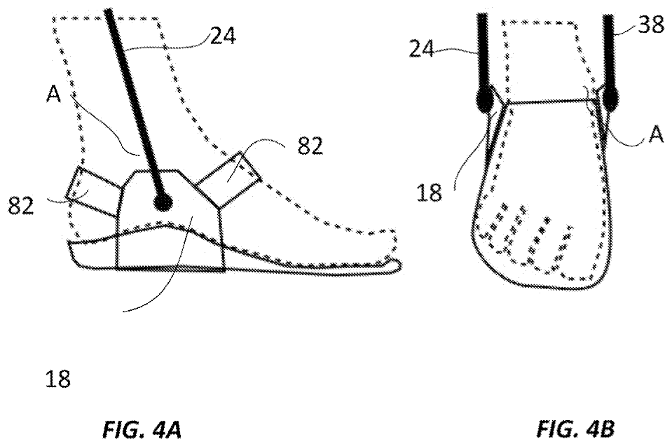

Referring now to the drawing figures, wherein like reference numbers refer to like elements throughout the several views, there is shown in FIGS. 1A and 1B an ankle exoskeleton device 10 for an ankle A of a human being B in accordance with an exemplary embodiment of the present invention. The human being B has a lower leg L which includes the ankle A. The ankle exoskeleton device 10 includes a lower leg anchor 12 (see FIGS. 3A, 3B and 3C) having a left side 14 and a right side 16, and a foot/ankle anchor 18 (see FIGS. 2A and 2B and FIGS. 4A and 4B) having a left side 20 and a right side 22. The ankle exoskeleton device 10 further includes a first actuator 24 having an upper end 26 disposed at a first anchor point 30 on the right side 22 of the foot/ankle anchor 18 and a lower end 28 disposed at a second anchor point 32 on the right side 16 of the lower leg anchor 12. The first actuator 24 includes a first biasing means 34 (e.g., a coil spring) which is in a neutral position C when the ankle is in a neutral position. The first biasing means 34 provides for compression loading due to ground reaction forces on the foot/ankle anchor 18 to provide a cushioning effect on the ankle A as the being B takes a step. For purposes of the present invention, the term “tension loading” is intended to include release or relaxation of compression loading, not requiring necessarily actual tension on the biasing means 34, 48.

A second actuator 38 is provided that includes an upper end 40 disposed at a third anchor point 44 on the left side 20 of the foot/ankle anchor 18 and a lower end 42 disposed at a fourth anchor point 46 on the left side 20 of the lower leg anchor 12. The second actuator 38 includes a second biasing means 48 (e.g., a coil spring) having a neutral position D when the ankle A is in the neutral position. The second biasing means 48 provides for compression loading due to ground reaction forces on the foot/ankle anchor 18 to provide a cushioning effect on the ankle A as the being B takes a step. Again, for purposes of the present invention, the term “tension loading” is intended to include release or relaxation of compression loading, not requiring necessarily actual tension on the biasing means 34, 48.

The first actuator 24 may include a first rod 50 having a first end 52 extending from the second anchor point 32. The first biasing means 34 may extend from a second end 54 of the first rod 50 to the first anchor point 32. The second actuator 32 may include a second rod 56 having a first end 58 extending from the fourth anchor point 46. The second biasing means 48 may extend from a second end 60 of the second rod 56 to the third anchor point 44.

Alternatively, the first actuator 24 may include the first rod 50 having the first end 52 extending from the first anchor point 30. The first biasing means 34 may extend from the second end 54 of the first rod 50 to the second anchor point 32 (not shown). Alternatively, the second actuator 38 may include the second rod 56 having a first end 58 extending from the third anchor point 44. The second biasing means 48 may extend from the second end 60 of the second rod 56 to the fourth anchor point 46 (not shown).

The first biasing means 34 and the second biasing means 48 of the ankle exoskeleton device 10 are intended to include any devices whatsoever that are suitable for the present application that provides appropriate spring force, for example, a coil spring, a leaf spring, a torsion spring, a flat spring, a gas spring, an air spring, any resilient material, and the like.

The neutral position C and the neutral position D (i.e., where the ankle A is in a neutral position) may include the biasing means 34, 48, e.g., coil springs, that are pre-loaded to achieve forces that are most consistent with the mechanical properties of uninjured joints.

The first actuator 24 of the ankle exoskeleton device 10 may have an upper end 26 that includes a first swivel joint attachment 64 for attachment to the first anchor point 30. The first actuator 24 may have a lower end 28 that includes a second swivel joint attachment 68 for attachment of the lower end 28 to the second anchor point 32.

The second actuator 38 may have an upper end 40 that includes a third swivel joint attachment 72 for attachment of the upper end 40 to the third anchor point 44. The second actuator 38 may have a lower end 42 that includes a fourth swivel joint attachment 76 for attachment of the lower end 42 to the fourth anchor point 46.

The first rod 50 and the second rod 56 may be threaded 78 to provide for length adjustment by screwing into threaded holes 80 in the swivel joint attachments 64, 68, 72, 76.

The biasing means 34, 48 may be tunable to provide for a desired spring rate, for example, the coil springs may include replaceable springs of varying spring rates to provide for tuning.

The foot/ankle anchor 18 and the lower leg anchor 12 may be manufactured from, for example, a composite material, including carbon and/or Kevlar, or a moldable thermoplastic material.

The foot/ankle anchor 18 may have adjustable straps 82 adapted to secure the foot/ankle anchor 18, and the lower leg anchor 12 may have adjustable straps 84 adapted to secure the lower leg anchor 12.

The ankle exoskeleton device provides for a portion of ground reaction forces to be transmitted from the ground to the lower leg, minimizing forces that pass through the ankle joint (tibiotalar joint), thus limiting the mechanical stress of using the ankle. The biasing means (such as coil springs) in the actuators spread the ground reaction force out over time, buffering against high instantaneous magnitude forces during movement. The biasing means is tunable—for example, one spring can either be swapped with a different spring with a different stiffness, or pre-compressed to achieve forces that are most consistent with the mechanical properties of uninjured joints. The ankle exoskeleton device of the present invention prevents the ankle from being inverting, eliminating the risk of inversion injury (i.e., “rolling one's ankle”). Furthermore, the ankle exoskeleton device of the present invention stabilizes the talus relative the tibia on the anterior-posterior and medio-lateral axes by placing appropriate anchors on the different parts of the ankle. The swivel joint attachments allow for full range of motion of the ankle along a single axis.

The various features of the present invention are designed to mechanically protect an unstable or injured ankle, while still allowing the ankle to be used in a biomechanically correct fashion. The device of the present invention does this through a combination of: 1) stabilizing the ankle joint and restricting its movement in ways that could potentially be damaging. For example, shearing movements between the tibia and talus of an unstable ankle are limited by the stabilizing actuators; 2) Lessening the mechanical toll of movement on the ankle by allowing some the ground reaction forces to bypass the ankle joint and itself and instead transmit to the lower leg through the actuators; and 3) Limiting high instantaneous forces and instead spreading them out over time using the elasticity of the biasing means.

The major design considerations for the design of the lower-leg and foot/ankle anchors are that they must be able to effectively transmit mechanical force, while minimizing unwanted consequences of wearing the device, such as impingement on nerves or blood supply. The component of the ankle exoskeleton device 10 most likely to cause such impingement is the lower strap 82 on the foot/ankle anchor 18. In certain embodiments of the present invention, this lower strap 82 may be omitted. Here, while less stabilization in the anterior direction may be available, the device 10 retains substantially all benefits noted herein.

Preventing irritation in places where the ankle exoskeleton device is in contact with the skin, especially in areas in which it transmits substantial force is desirable. To account for this, at every surface where the device contacts skin (e.g., lower leg anchor, lower leg anchor—both rigid medial/lateral sides and anterior/posterior straps), a cushioning, skin-compatible substance is preferably utilized. For example, a thermoplastic elastomer gel with mineral oil may be used. The gel may, for example be bonded or sewn on.

No existing ankle device combines the advantages of the present ankle exoskeleton device, including, for example: 1) ankle inversion protection, 2) medial/lateral/anterior/posterior stabilization of the talus, 3) allowing force to bypass the tibiotalar joint, 4) providing the cushioning effect of the compression spring to limit high instantaneous forces, and 5) enabling normal movement of the ankle along a single axis hinge. The combination of these features gives this device a unique ability to protect the ankle while nonetheless maintaining relatively normal biomechanics, which means it can be used in everyday situations.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. An ankle exoskeleton device for an ankle of a being, the being having a lower leg and an ankle, the ankle exoskeleton device comprising:
(a) a lower leg anchor having a left side and a right side;
(b) a foot/ankle anchor having a left side and a right side;
(c) a first actuator comprising an upper end disposed at a first anchor point on the right side of the foot/ankle anchor and a lower end disposed at a second anchor point on the right side of the lower leg anchor, the first actuator comprising a first biasing means, the first biasing means having a neutral position when the ankle is in a neutral position, the first biasing means providing for compression loading due to ground reaction forces on the foot/ankle anchor to provide a cushioning effect on the ankle as the being takes a step;
(d) a second actuator comprising an upper end disposed at a third anchor point on the left side of the foot/ankle anchor and a lower end disposed at a fourth anchor point on the left side of the lower leg anchor, the second actuator comprising a second biasing means, the second biasing means having a neutral position when the ankle is the a neutral position, the second biasing means providing for compression loading due to ground reaction forces on the foot/ankle anchor to provide a cushioning effect on the ankle as the being takes a step;
whereby the device mechanically cushions and stabilizes the ankle along anterior posterior and medial-lateral directions of the ankle.

2. The ankle exoskeleton device of claim 1, wherein the first actuator comprises a first rod having a first end extending from one of the first anchor point and the second anchor point, and wherein the first biasing means extends from a second end of the first rod to the other of the first anchor point and the second anchor point, and wherein the second actuator includes a second rod comprising a first end extending from one of the third anchor point and the fourth anchor point, and wherein the second biasing means extends from a second end of the second rod to the other of the third anchor point and the fourth anchor point.

3. The ankle exoskeleton device of claim 1, wherein the biasing means is a coil spring.

4. The ankle exoskeleton device of claim of claim 1, wherein the neutral positions of the first and second actuators include the biasing means that are pre-loaded to achieve forces that are most consistent with the mechanical properties of uninjured joints.

5. The ankle exoskeleton device of claim 1, wherein the first actuator has an upper end that includes a first swivel joint attachment for attachment to the first anchor point, and the first actuator has a lower end that includes a second swivel joint attachment for attachment of the lower end to the second anchor point.

6. The ankle exoskeleton device of claim 1, wherein the second actuator has an upper end that includes a third swivel joint attachment for attachment of the upper end to the third anchor point, and the second actuator has a lower end that includes a fourth swivel joint attachment for attachment of the lower end to the fourth anchor point.

7. The ankle exoskeleton device of claim 1, wherein the first rod and the second rod are threaded to provide for length adjustment.

8. The ankle exoskeleton device of claim 1, wherein the biasing means is tunable to provide for a desired spring rate.

9. The ankle exoskeleton device of claim 3, wherein the coil springs comprise replaceable springs of varying spring rates to provide for tuning,

10. The ankle exoskeleton device of claim 1, wherein the foot/ankle anchor and the lower leg anchor are manufactured from a composite material.

11. The ankle exoskeleton device of claim 1, wherein the foot/ankle anchor and the lower leg anchor are manufactured from a moldable thermoplastic material.

12. The ankle exoskeleton device of claim 1 wherein the foot/ankle anchor has adjustable straps adapted to secure the foot/ankle anchor, and wherein the lower leg anchor has adjustable straps adapted to secure the lower leg anchor.

13. An ankle exoskeleton device for use on an ankle of a being, the being having a lower leg and an ankle, the ankle exoskeleton device comprising:
(a) a lower leg anchor having a left side and a right side
(b) a foot/ankle anchor having a left side and a right side
(c) a first actuator comprising an upper end disposed at a first anchor point on the right side of the foot/ankle anchor and a lower end disposed at a second anchor point on the right side of the lower leg anchor, the first actuator comprising a first coil spring, the first coil spring having a neutral position when the ankle is in a neutral position, the first biasing means providing for compression loading due to ground reaction forces on the foot/ankle anchor to provide a cushioning effect on the ankle as the being takes a step, wherein the first actuator comprises a first rod having a first end extending from one of the first anchor point and the second anchor point, and wherein the first coil spring extends from a second end of the first rod to the other of the first anchor point and the second anchor point;
(d) a second actuator comprising an upper end disposed at a third anchor point on the left side of the foot/ankle anchor and a lower end disposed at a fourth anchor point on the left side of the lower leg anchor, the second actuator comprising a second coil spring, the second coil spring having a neutral position when the ankle is in a neutral position, the first biasing means providing for compression loading due to ground reaction forces on the foot/ankle anchor to provide a cushioning effect on the ankle as the being takes a step, wherein the second actuator includes a second rod having a first end extending from one of the third anchor point and the fourth anchor point, and wherein the second coil spring extends from a second end of the second rod to the other of the third anchor point and the fourth anchor point;
whereby the device mechanically cushions and stabilizes the ankle along anterior-posterior and medial-lateral directions of the ankle.

14. The ankle exoskeleton device of claim of claim 13, wherein the second positions of the first and second actuators include the coil springs that are pre-loaded to achieve forces that are most consistent with the mechanical properties of uninjured joints.

15. The ankle exoskeleton device of claim 13, wherein the first actuator has an upper end that includes a first swivel joint attachment for attachment to the first anchor point, and the first actuator has a lower end that includes a second swivel joint attachment for attachment of the lower end to the second anchor point.

16. The ankle exoskeleton device of claim 13, wherein the second actuator has an upper end that includes a first swivel joint attachment for attachment of the upper end to the third anchor point, and the second actuator has a lower end that includes a second swivel joint attachment for attachment of the lower end to the fourth anchor point.

17. The ankle exoskeleton device of claim 13, wherein the first rod and the second rod are threaded to provide for length adjustment.

18. The ankle exoskeleton device of claim 13, wherein the coil springs comprise replaceable springs of varying spring rates to provide for tuning,

19. The ankle exoskeleton device of claim 13, wherein the foot/ankle anchor and the lower leg anchor are manufactured from a composite material or a moldable thermoplastic material.

20. The ankle exoskeleton device of claim 13 wherein the foot/ankle anchor has adjustable straps adapted to secure the foot/ankle ancho, and wherein the lower leg anchor has adjustable straps adapted to secure the lower leg anchor.
